(19) United States
(12) Patent Application Publication
(10) Pub. No.: US 2011/0134130 A1
(43) Pub. Date: Jun. 9, 2011

(54) METHOD AND APPARATUS FOR OPERATING OPTIONAL KEY MAP OF PORTABLE TERMINAL

(75) Inventor: Hyun Bae CHOI, Gumi-si (KR)

(73) Assignee: SAMSUNG ELECTRONICS CO. LTD., Suwon-si (KR)

(21) Appl. No.: 12/960,863

(22) Filed: Dec. 6, 2010

(30) Foreign Application Priority Data
Dec. 8, 2009 (KR) 10-2009-0121314

(51) Int. Cl. G06T 11/00

(52) U.S. Cl. 345/467

(57) ABSTRACT

An optional key map operation and apparatus of a portable terminal are provided for compensating for the fixedness of a key map to facilitate generating input signals. A method for operating an optional key map of a portable terminal according to the present invention includes displaying at least one basic key map generated according to a predetermined standard, and displaying at least one optional key map linked to the at least one basic key map along with the at least one basic key map.

### PRIORITY

This application claims the benefit under 35 U.S.C. §119(a) of a Korean patent application filed on Dec. 8, 2009 in the Korean Intellectual Property Office and assigned Serial No. 10-2009-0121314, the entire disclosure of which is hereby incorporated by reference.

### BACKGROUND OF THE INVENTION

1. Field of the Invention

The present invention relates to a portable terminal. More particularly, the present invention relates to an optional key map operation and apparatus of a portable terminal for compensating for the fixedness of a key map to facilitate generating input signals.

2. Description of the Related Art

A portable terminal is a device that has a plurality of useful functions and that a user can transport with ease. These two advantages have resulted in the widespread use of portable terminals. Typically, a portable terminal is provided with at least one input device for receiving user input. For example, the conventional portable terminal is provided with a keypad which is arranged on a side of the terminal body and has a plurality of alphanumeric keys for receiving alphabetic and numeric key inputs. Recently, in order to ensure adequate space for a relatively large display without compromising portability which depends on the physical size of the terminal, the traditional keypad has been replaced by a touchscreen that functions as an input device as well as a display device.

Conventional touchscreen-enabled portable terminals tend to be designed with key maps that are displayed on the screen to receive the user input without an additional input device, resulting in a light weight and a slim design. Typically, since the key maps of a portable terminal are designed according to a specific standard, it is required for the user to adapt to the standard and manage to use the key maps according to the standard. However, with the conventional key map-based portable terminal, the user has to make input with repetitive key manipulation especially for inputting a character repeatedly or a specific character according to the rule of the standard, resulting in the user's inconvenience.

### SUMMARY OF THE INVENTION

An aspect of the present invention is to address at least the above-mentioned problems and/or disadvantages and to provide at least the advantages described below. Accordingly, an aspect of the present invention is to provide an optional key map operation and apparatus of a portable terminal that is capable of facilitating a user-intended character, resulting in improving a user's convenience.

In accordance with an aspect of the present invention, a method for operating an optional key map of a portable terminal is provided. The method includes displaying at least one basic key map generated according to a predetermined standard, and displaying at least one optional key map linked to the at least one basic key map along with the at least one basic key map.

In accordance with another aspect of the present invention, an apparatus for operating an optional key map of a portable terminal is provided. The apparatus includes a storage unit for storing at least one basic key map generated according to a predetermined standard and at least one optional key map linked to the at least one basic key map, a control unit for controlling to display the at least one basic key map and the at least one optional key map simultaneously according to an input signal for displaying the basic key map, and a touchscreen for displaying the at least one basic key map and the at least one optional key map.

### BRIEF DESCRIPTION OF THE DRAWINGS

The above and other aspects, features and advantages of certain exemplary embodiments of the present invention will be more apparent from the following detailed description in conjunction with the accompanying drawings, in which:

FIG. 1 is a block diagram illustrating a configuration of a portable terminal supporting an optional key map control mechanism according to an exemplary embodiment of the present invention;

FIG. 2 is a diagram illustrating a process for creating an optional key map in an optional key map operation according to an exemplary embodiment of the present invention;

FIG. 3 is a diagram illustrating a user interface providing an optional key map in a portable terminal according to an exemplary embodiment of the present invention; and

FIG. 4 is a flowchart illustrating an optional key map operation for a portable terminal according to an exemplary embodiment of the present invention.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the description and claims are not to be limited to ordinary meanings or dictionary definitions. Under the principles that the inventors are entitled to act as his or her own lexicographer in order to explain his or her own invention in the best way, those terms and words are to be construed so as to conform to the technical concept of the present invention. The constructions disclosed in the specification and drawings show exemplary embodiments of the invention, but do not represent all the technical concepts of the invention. It is therefore understood that at the time of filing this application, various alternatives and modifications to these constructions may occur to those skilled in the art.

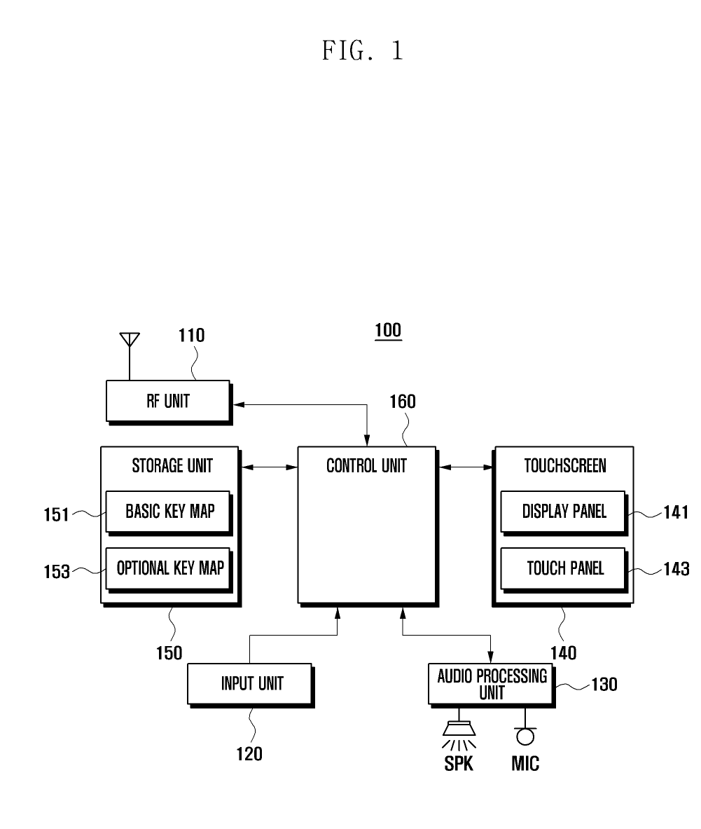

FIG. 1 is a block diagram illustrating a configuration of a portable terminal supporting an optional key map control mechanism according to an exemplary embodiment of the present invention.

Referring to FIG. 1, the portable terminal 100 includes a Radio Frequency (RF) unit 110, an input unit 120, an audio processing unit 130, a touchscreen 140, a storage unit 150, and a control unit 160.

The portable terminal 100 according to an exemplary embodiment of the present invention can display a basic key map 151 and an optional key map 153, which are stored in the storage unit 150, on the touchscreen 140 according to the user's manipulation such that the user can input specific and/or special characters with the user-specific optional key map 153 as well as the basic key map 151. Here, the basic key map 151 denotes one or more key maps predesigned according to a specific standard, and the optional key map 153 denotes the one or more key maps including supplementary keys customized by the user. A description is made of the internal function blocks of the portable terminal 100 hereinafter.

The RF unit 110 is responsible for establishing a communication channel for exchanging data related to the voice and video calls under the control of the control unit 160. That is, the RF unit 110 can establish a radio channel with a mobile communication system for voice, data, and video communications. For this purpose, the RF unit 110 includes an RF transmitter for up-converting and amplifying transmission signals and an RF receiver for low-noise-amplifying and down-converting received signals. The user can make a call with the RF unit 100 by selecting an information item corresponding to a recipient from a phonebook or inputting a number representing the recipient. More particularly when the portable terminal is provided with a touchscreen other than a keypad or buttons, the basic key map 151 having numeric characters is displayed on the touchscreen 140. Here, the basic key map 151 can be a 3×4 key map, a 4×3 key map, and the like.

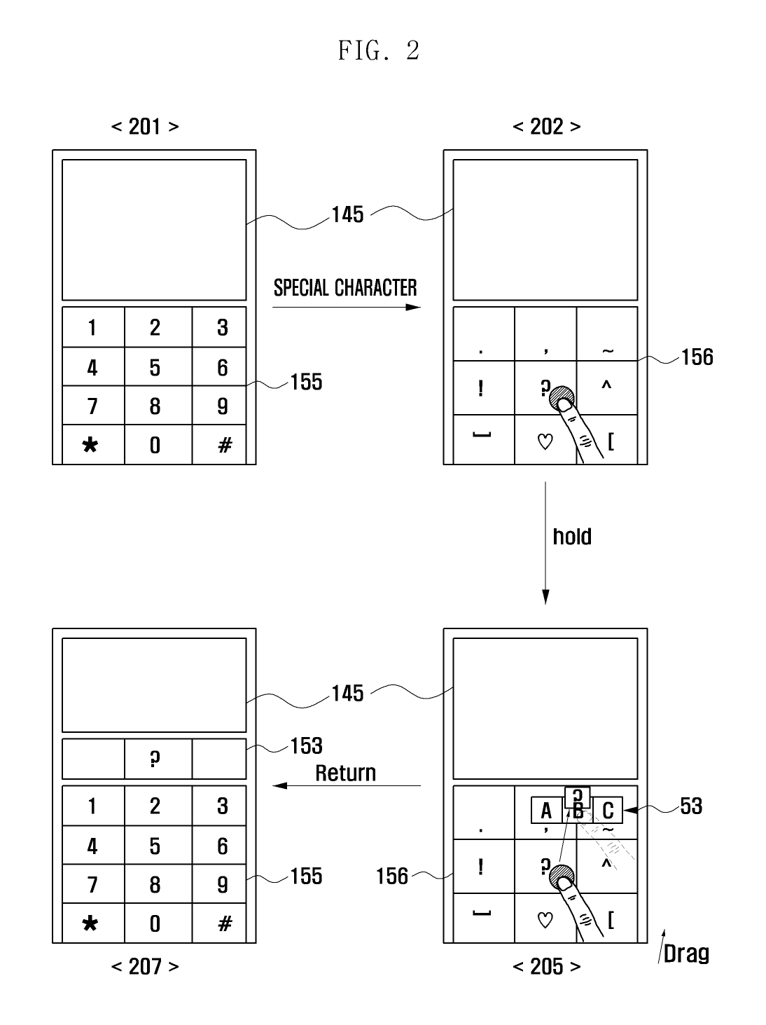

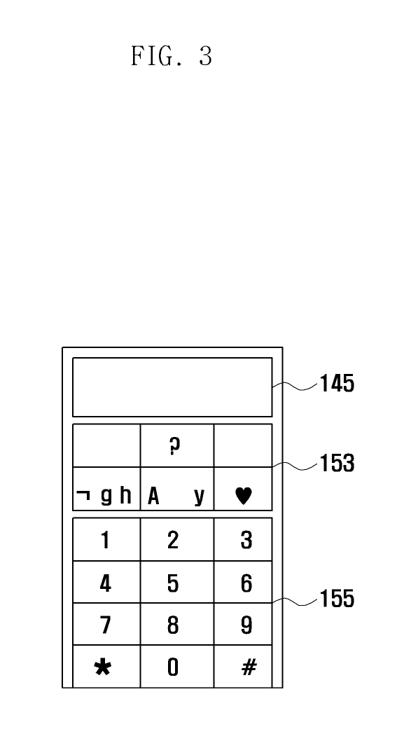

The input unit 120 includes a plurality of alphanumeric and function keys for inputting alphabetic and numeric information and various function execution commands. The function keys can include navigation keys, side keys, and shortcut keys. The input unit 120 can include side keys formed on a side of the terminal casing, especially when the portable terminal has a touchscreen, without additional key buttons or a keypad. In case of a touchscreen-enabled portable terminal, the portable terminal is provided with the basic key map 151 having a plurality of keys. The basic key map 151 can be implemented in the form of a QWERTY key map, a 3×4 key map, a 4×3 key map, a menu map, a soft key map, etc. More particularly, the input unit 120 can include an optional key map 153 formed with specific characters and special characters selected from the basic key map 151. The optional key map 153 is arranged near the basic key map 151. A description is made of the display of the optional key map 153 below with reference to FIGS. 2 and 3.

The audio processing unit 130 includes a speaker (SPK) for outputting audio data of an ongoing call, a voice message, an audio file stored in the storage unit 150, and the like. The audio processing unit 130 also includes a microphone (MIC) for receiving a user's voice and other audio signals. The audio processing unit 130 can be configured to output, when the basic key map 151 and the optional key map 153 are displayed on the touch screen 140, a specific sound effect alarming of the presentation of the key maps 151 and 153. In case that the optional key map 153 is displayed while the basic key map 151 has been displayed already, the audio processing unit 130 can output a sound effect alarming of the presentation of the optional key map 153. The sound effect output can be turned on or off according to the user settings.

The touchscreen 140 includes a display panel 141 and a touch panel 143. The touchscreen 140 can be configured such that the front surface of the touch display panel 141 is covered by the touch panel 143. The size of the touchscreen 140 can be determined by the size of the touch panel 143. For example, the touchscreen 140 can be implemented over the entire surface of the display panel 141 (i.e., in the form of a full touchscreen).

The display panel 141 displays the various menus of the portable terminal 100 and information input by and provided to the user. That is, the display panel 141 displays various execution screens such as an idle mode screen, a menu screen, a message composition screen, and a call progressing screen. The display panel 141 can be implemented with a Liquid Crystal Display (LCD) or an Organic Light Emitted Diode (OLED). In case that the display panel 141 forms the touchscreen 140 together with the touch panel 143, the touchscreen 140 can work as a part of the input unit 120. More particularly, in an exemplary embodiment of the present invention, the display unit 141 can display the basic key map 151 stored in the storage unit 150 under the control of the control unit 160. The display panel 141 also can display the optional key map 153 stored in the storage unit 150 under the control of the control unit 160. The optional key map 153 can be generated or modified by referencing the basic key map 151 which has been already displayed on the display panel 141. A description is made of generating and modifying the optional key map 153 below with reference to drawings.

The touch panel 143 is arranged over the upper surface of the display panel 141 to detect a touch made at a position of an image or an item presented on the display panel 141. The touch panel 143 can be configured such that, when the basic key map 151 is displayed on the display panel 141, it is set adaptive to the basic key map 151. Once the touch panel 143 has been set, the user can input a specific alphanumeric character or a special character of the basic key map 151 by making a touch at a position of the touch panel 143.

The storage unit 150 can store application programs required for executing functions according to an exemplary embodiment of the present invention and the basic key map 151 for operation with the touchscreen 140. The basic key map 151 can include a key map, a menu map, and a soft key map. Here, the key map and menu map can be formed in various types. That is, the key map can be implemented in the form of a keyboard map, a 3×4 key map, a QWERTY key map, an application-specific control key map for controlling the currently running application program, and the like. Also, the menu map can be an application-specific menu map showing the menu items related to the currently running application program or a common menu map showing various menu items representing menus provided by the portable terminal 100. The storage unit 150 can include a program region and a data region.

The program region stores an Operating System (OS) for booting the portable terminal 100 and managing internal function blocks and application programs for processing various types of data files such as a communication application program responsible for supporting communication functions of the portable terminal 100, a web browser for supporting Internet access, an MP3 application program for playing MP3 audio resources, a picture display application program for displaying pictures including photographs, a video playback application program for playing motion picture files, and the like. More particularly, in an exemplary embodiment of the present invention, the program region stores the application program for supporting the optional key map control mechanism.

The optional key map application program can support configuration of the optional key map 153 while the basic key map 151 is displayed. The optional key map application program can operate such that the user can generate an optional key map or modify the previously generated optional key map while the basic key map 151 is displayed. For this purpose, the optional key map application program includes a routine for extracting the optional key map 153 linked to the basic key map 151 when the basic key map 151 is displayed in response to a user's manipulation, a routine for controlling such that the optional key map 153 linked to the basic key map 151 is displayed at a preset position of the display panel 141, and a routine for controlling such that an object such as a character located at a position where a touch is made is applied to the currently running application program. The optional key map application also can include a routine for defining an optional key registration region to generate the optional key map 153 in response to a user's manipulation after the display of the basic key map 151 on the display panel 141, a routing for creating an optional key map 153 or modifying the previously created optional key map 153 by moving the user-selected character to the optional key registration region in response to the user's request, and a routine for storing the optional key map 153 along with the link to the currently displayed basic key map 151. The optional key map application program can call the optional key map 153 which is previously stored in the data region, when the optional key map 153 is required to be modified. When a specific basic map 151 is displayed on the display panel 141 as a consequence of the activation of a specific function, the aforementioned routines are loaded on the control unit 160 for outputting, creating, and/or modifying the optional key map 153.

The data region stores the data generated during the operation of the portable terminal 100 and various types of data such as phonebook data and objects such as icons representing contents and widgets. In case that the display panel 141 is implemented as a part of the touchscreen 140, the data region can store the touch event signals corresponding to the user inputs input on the touchscreen 140. More particularly, in an exemplary embodiment of the present invention, the data region can store various types of basic key maps 151 and user-specific optional key maps 153. As aforementioned, the basic key maps 151 are the key maps designed by a designer according to a predetermined standard. The optional key map 153 is a post-registered map generated with the characters selected by the user from the basic key map 151. The optional key map 153 can be generated with the links to multiple basic key maps 151 according to the user settings and include the information on the links to the basic key maps 151 and/or other optional key maps.

The control unit 160 controls a power supply to initialize the internal function blocks of the portable terminal 100 and controls the functions blocks to output the user interface for supporting the optional key map 153 and display the optional key map 153 in response to an input signal. More particularly, the control unit 160 controls such that a specific user function is activated in response to an input signal and a basic key map 151 related to the specific user function is displayed on the display panel 141. When a specific application program is activated, the control unit 160 determines whether an optional key map linked to the basic key map 151 exists and, if the optional key map linked to the basic key map 151 exists, controls such that the optional key map is displayed at a specific position of the display panel 141. In case that a plurality of optional key maps are linked to the basic key map 151, the control unit 160 controls such that the plural optional key maps are displayed at specific positions in relation to the position of the basic key map 151. The optional key maps 153 linked to the basic key map 151 can be different from each other in shape. If a user manipulation (such as a menu item selection, a key input, or a touch event) requesting creation or modification of an optional key map is detected while the basic key map 151 is displayed, the control unit 160 can control to display the user interface for supporting the creation or modification of the optional key map 153. A description is made of the type, creation, and modification of the optional key map 153 in more detail below with reference to drawings.

FIG. 2 is a diagram illustrating a process for creating an optional key map in an optional key map operation according to an exemplary embodiment of the present invention. The description is made with a set of exemplary basic key maps 155 (i.e., a 3×4 key map) and a special key map 156.

Referring to FIGS. 1 and 2, when a user powers up the portable terminal 100, the control unit 160 controls in response to a menu selection such that a specific basic key map 151 (i.e., 3×4 key map 155) is displayed on the display panel 141. In more detail, the control unit 160 of the portable terminal 100 controls such that a menu screen having a list of application programs operating with the 3×4 key map 155 is displayed. The user can select an application program (e.g., a voice call execution item) from the menu screen. If the voice call execution item is selected by the user, the control unit 160 controls such that a voice call execution screen having the 3×4 key map 155 occupying the lower half of the display panel 141 is displayed and a text window 145 occupying the upper half of the display panel 141 is displayed and displaying the alphanumeric characters selected on the 3×4 key map 155.

The portable terminal user can activate a function for creating an optional key map 153 including special characters while the 3×4 key map 155 is displayed on the display panel 141. For example, the user can activate a menu and select a menu item for displaying the special character key map 156 including special characters such that the special character key map 156 is displayed on the display panel 141 as shown in the screen image 202. Here, the special character key map 156 can be configured to be displayed when a predetermined hot key is activated as well as when an item is selected from the menu. While the special character key map 156 is displayed, the portable terminal user can select one of the special characters (e.g., “?”). Next, the user can generate an input signal for registering the special character with the optional key map 153. For example, the user may touch a position where the special character is presented on the touchscreen 140 displaying the special character key map 156 and maintain the touch over a predetermined time duration to select the desired character.

If the touch event and the hold event are detected, the control unit 160 of the portable terminal 100 can output the user interface to allow registering special characters with the optional key map 153. In more detail, the control unit 160 can control such that an optional key registration region 53 is displayed at a region on the display unit 141. For example, the control unit 160 can control such that the optional key registration region 53 is overlaid on the special character key map 156. Next, the portable terminal user can drag and drop the intended special character at a specific position in the optional key registration region 53. The optional key registration region 53 can be formed as a single section or a set of multiple sections (e.g., three separate areas) as shown in the drawing. Accordingly, the user can move the selected special character to one of the sections of the optional key registration region 53. At this time, in order for the user to recognize the movement of the special character to be registered, the control unit 160 can control such that the movement progress of the selected character is expressed on the display panel 141 in synchronization with the drag and drop event. If the dragged special character is dropped at the section B of the optional key registration region 53 (i.e., a touch-up event is detected) the control unit 160 determines that an input signal for registering the special character has occurred. Although the description is directed to the case where the character is dragged and dropped to the optional key registration region 53, the present invention is not limited thereto. That is, the portable terminal user can register a specific character with the optional key map 153 in any of various manners supported by the portable terminal 100. For example, the control unit 160 of the portable terminal 100 can recognize a predetermined number of tap events made at a position for the intended-character as an input command to move the corresponding character to the optional key registration region 53 automatically. The optional key registration region 53 is configured such that a plurality of characters can be registered therewith. In case that the optional key registration region 53 is divided into three sections (i.e., regions A, B, and C) as shown in the screen image 205, the user can register one special character with each section of the optional key registration region 53. Of course, the optional key registration region 53 can be provided with more than three sections depending on the user settings. For example, the portable terminal user can increase the number of sections of the optional key registration region 53 (e.g., 4, 6, or 9 sections) by executing a touch event at a corner and a touch-drag event in a diagonal direction.

After the special key registration with the optional key map has been completed by performing steps represented by screen images 202 and 205, the user can generate an input signal to return to the screen image presenting the 3×4 key map 155. Here, the input signal can be generated in any of various manners supported by the portable terminal 100 (e.g., by selecting a menu item or a hot key assigned for the command to return to a previous screen item). The control unit 160 of the portable terminal 100 can control such that the 3×4 key map 155 and the optional key map 153 are displayed at one side of the display panel 141 as shown in the screen image 207. At this time, the control unit 160 can control such that the text window 145 is adjusted in size and thus the optional key map 153 is arranged between the text window 145 and the 3×4 key map 155. Although the optional key map 153 is depicted having three sections in the screen image 207, the present invention is not limited thereto. That is, the control unit 160 can control such that the optional key map 153 is presented only with the sections to which specific characters are assigned, according to the user settings or default terminal configuration.

After the optional key registration has been completed as shown in the screen image 205, if the optional key map 153 is displayed as shown in the screen image 207, the control unit 160 of the portable terminal 100 can control such that the optional key map 153 is saved along with the link to the 3×4 key map 155 as the basic key map 151. Afterward, if an input signal for activating the same user function is detected, the control unit 160 of the portable terminal 100 controls such that the screen images 201 to 207 are presented. In the meantime, the portable terminal 100 can be configured to provide a mode in which the optional key map 153 is displayed along with the basic key map as shown in the screen image 207. That is, the portable terminal 100 can support a dual key map display mode for displaying the optional key map 153 with the basic key map 151 simultaneously and a single key map display mode for displaying only the basic key map. The portable terminal 100 displays only the basic key map 151 or both the basic key map 151 and the optional key map 153 depending on the key map display mode selected by the user. At this time, the basic key map 151 can be maintained in a predetermined size, and each of the key sections of the optional key map 153 is identical with an individual key section of the basic key map 151 in size.

As aforementioned, the portable terminal 100 according to an exemplary embodiment of the present invention provides an optional key map 153 as well as a basic key map 151 in order for the user to input characters more easily, especially with the user-defined optional key map.

Although the description is directed to the case where the optional key map 153 is generated by referencing a special character key map displayed following the 3×4 key map 155 and saved along with the link to the 3×4 key map 155, the present invention is not limited thereto. That is, the optional key map 153 can be generated in accordance with the input signal for displaying the aforementioned optional key registration region 53 while the 3×4 key map 155 is displayed and saved along with the link to the 3×4 key map 155. The optional key map 153 generated based on the special character key map 156 can be saved with the link to the special character key map 156 as well as the 3×4 key map 155 according to the user selection.

FIG. 3 is a diagram illustrating a user interface providing an optional key map in a portable terminal according to an exemplary embodiment of the present invention.

Referring to FIGS. 1 to 3, the display panel 141 displays an execution screen having a text window 145, an optional key map 153, and a basic key map 151, (e.g., 3×4 key map 155). The user can manipulate the portable terminal 100 to activate a specific user function. If an input signal for activating a specific user function is detected, the control unit 160 of the portable terminal determines the basic key map 151 linked to the corresponding user function and whether any optional key map 153 linked to the basic key map 151 exists. At this time, the control unit 160 can also determine whether the current map display mode is the dual key map display mode for displaying both the basic and optional key maps simultaneously in advance. In case that the portable terminal is in the dual key map display mode, the control unit 160 of the portable terminal 100 controls such that the basic key map 151 related to the corresponding user function (i.e., 3×4 key map) is displayed at the lower part of the display panel 141.

Although the basic key map 151, the optional key map 153, and the text window are depicted in order from the bottom to the top of the display panel 141 in FIG. 3, the arrangement is not limited thereto but can be changed. That is, the control unit 160 can control such that the basic key map 151 is presented at the top of the display panel 141 with the optional key map 153 at the bottom of the display panel 141 and the text window between the basic and optional key maps 151 and 153. The control unit 160 also can control such that the optional key map 153 is displayed at the top of the display panel 141 with the text window 145 at the bottom of the display panel and the optional key pad 153 between the basic key pad 151 and the text window 145.

In the illustrated example, the optional key map 153 includes six sections to which the characters selected by the user can be assigned. The characters assigned to the individual sections can include special characters and/or the alphanumeric characters selected from various basic key maps 151. For example, the optional key map 153 can be created with the characters selected from a primary language key map (e.g., Korean key map), a lower case English key map, an uppercase English key map, a special character key map, and the like.

The control unit 160 can control such that the optional key map 153 is maintained in a predetermined size regardless of the display mode of the display panel 141 such that the user can use the optional key map 153 and the 3×4 key map 155 appropriately. For example, the control unit 160 can control such that the space occupied by the optional key map 153 in a 2×3 matrix is twice as large as compared with the space occupied by the optional key map 153 in a 1×3 matrix. The control unit 160 can also control such that each of the sections of the optional key map 153 is identical with the size of each section of the 3×4 key map 155. For this purpose, the control unit 160 can adjust the size of the text window 145. The optional key map 153 can be saved with the link to the currently running application program or the basic key map 151 output with the currently running application program.

Although the description is directed to the case where an optional key map 153 is created and displayed according to the user's intention, the portable terminal 100 can load the previously stored optional key map 153 in response to an input signal for activating an application program such as a text messaging program, a text composition program, an email program, and the like, and calling an optional key map 153. At this time, the control unit 160 can control such that the optional key maps 153 are displayed in the form of a downsized image list or a multiple image format in order to be recognized more easily by the user. The user can check the downsized images of the optional key maps 153 and call the corresponding optional key map to register additional characters therewith. The control unit 160 also can support deleting a specific character registered with the optional key registration region 53 while the optional key map 153 is displayed. That is, if the optional key registration region 53 having registered characters is displayed on the display panel 141, the user can make a touch drag out of the corresponding optional key registration region to delete the corresponding character, resulting in deletion of the corresponding character. Although the description is directed to the exemplary case where a single optional key map 153 is displayed with the basic key map 151 in FIGS. 2 and 3, it is possible to display a plurality of optional key maps 153 with a basic key map 151 on the display panel 141.

Until now, the structures and functions of the internal function blocks of the portable terminal supporting optional key maps according to exemplary embodiments of the present invention have been described. An optional key map operation according to an exemplary embodiment of the present invention is described hereinafter with reference to drawings.

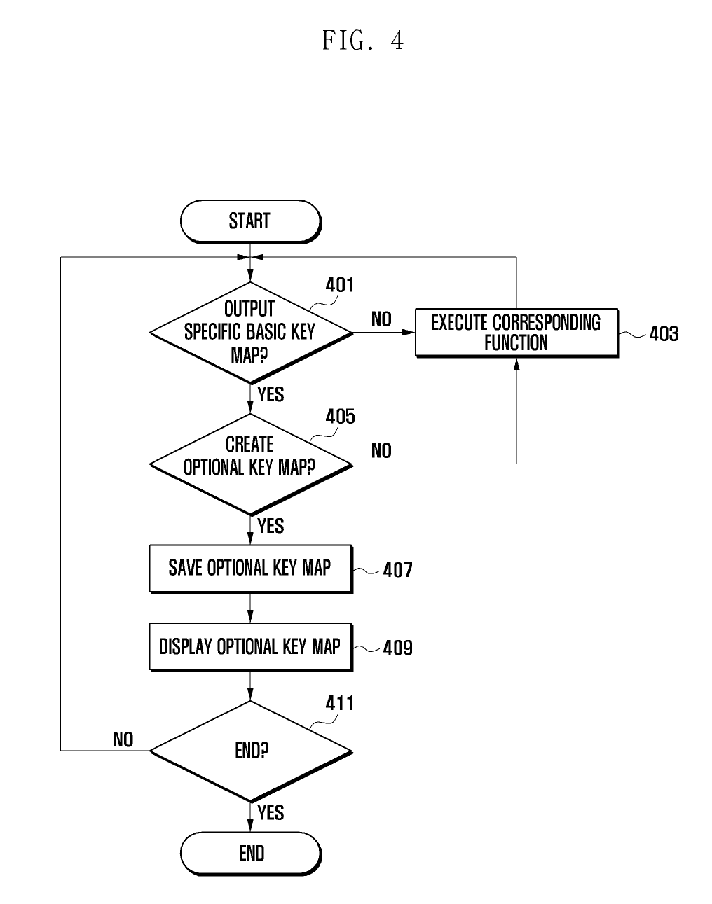

FIG. 4 is a flowchart illustrating an optional key map operation for a portable terminal according to an exemplary embodiment of the present invention.

Referring to FIGS. 1 to 4, in the optional key map operation according to an exemplary embodiment of the present invention, once the portable terminal 100 powers up, the control unit 160 of the portable terminal 100 initializes the internal function blocks, executes routines according to a predetermined schedule, and determines whether an input signal for activating an application program requiring a specific basic key map 151 is generated by means of the input unit 120 or the touchscreen 140 in step 401. If it is determined in step 401 that an input signal for activating an application program requiring a basic key map 151 is not generated, the control unit 160 executes a function corresponding to the input signal in step 403. For example, the control unit 160 can control such that the portable terminal 100 executes a file search function, a file playback function, a time checking function, and the like according to the input signal at step 403.

On the other hand, if it is determined in step 401 that an input signal for activating an application program requiring a basic key map 151 is generated, the control unit 160 monitors to detect an input signal and, if an input signal is detected, determines whether the input signal is an optional key map creation request signal in step 405. As aforementioned, the optional key map creation request signal can be generated by a predetermined touch event made on the touchscreen 140, a selection of a predetermined hot key, a selection of a menu item, and the like. If it is determined in step 405 that the detected input signal is not the optional key map creation request signal, the procedure proceeds to step 403 such that the control unit 160 executes a function corresponding to the input signal.

If it is determined in step 405 that the detected input signal is the optional key map creation request signal, the control unit 160 displays an optional key registration region 53 for creating an optional key map 153 and registers characters selected by the user commands input through the input unit 120 or the touchscreen 140. Next, the control unit 160 controls such that the optional key map 153 created with at least one character registered with the optional key registration region 53 is stored in the storage unit 150 in step 407. At this time, the control unit 160 can control such that the optional key map 153 is stored with the link to the currently activated application program or the basic key map 151 of the currently activated application program. Afterward, if the corresponding application program is activated or the corresponding basic key map 151 is called, the control unit 160 controls such that the corresponding optional key map 153 is displayed.

Once the optional key map 153 has been saved successfully, the control unit 160 controls such that the saved optional key map 153 is displayed on the display panel 141 in step 409. At this time, the control unit 160 can control such that the text window 145 is adjusted to display the optional key map in a predetermined size without changing the size of the basic key map 151. Next, the control unit 160 monitors to detect an input signal and, if an input signal is detected, determines whether the input signal is a termination request signal in step 411. If it is determined in step 411 that a termination request signal is not detected, the procedure returns to step 401. On the other hand, if it is determined in step 411 that the termination request signal is detected, the control unit 160 ends the procedure.

In an exemplary implementation, steps 405 and 407 depicted in FIG. 4 can be omitted according to the operation mode of the portable terminal 100. That is, assuming that an input signal for displaying a specific basic key map 151 is input despite the user not wanting to use any optional key map, the control unit 160 can determine whether there is any optional key map 153 linked to the corresponding basic key map 151 at step 401. If there is any optional key map 153 linked to the corresponding basic key map 151, the control unit 160 controls such that the optional key map 153 is displayed at step 409. The optional key map generation process can be implemented with steps 401, 405, 407, and 409; and the optional key map display process can be implemented with steps 401 and 409.

As described above, the optional key map operation of a portable terminal according to an exemplary embodiment of the present invention is capable of inputting frequently used characters efficiently by allowing the user to register various characters with an optional key map and set the portable terminal to one of a dual key map display mode and a single key map display mode.

The portable terminal 100 can further include at least one of a short range communication module for short range communication, a camera module for taking a still/motion picture of an object, an interface for supporting data communication according to the wired and wireless communication protocols supported by the portable terminal 100, an Internet communication module for supporting Internet access via internet, a digital broadcast module for receiving and playing digital broadcast data, and their equivalents. Although not enumerated here, other devices equivalent to the aforementioned function modules can be further included in the mobile terminal. Also, it is obvious to those skilled in the art that each of the internal function blocks constituting the wireless device 100 can be omitted or replaced by other equivalent device.

The portable terminal 100 according to an exemplary embodiment of the present invention can be any of the devices supporting basic key maps 151 and optional key maps 153. For example, the portable terminal 100 can be any of the mobile communication terminals operating with various communication protocols, a Portable Multimedia Player (PMP), a digital broadcast player, a Personal Digital Assistant (PDA), a music player (e.g., MP3 player), a portable game console, a handheld PC, and their equivalent multimedia and application devices.

As described above, the optional key map operation and apparatus of a portable terminal according to exemplary embodiments of the present invention are capable of facilitating input of characters using at least one optional key map having characters registered by the user that is presented selectively along with a basic key map.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for operating an optional key map of a portable terminal, the method comprising:
displaying at least one basic key map generated according to a predetermined standard; and
displaying at least one optional key map linked to the at least one basic key map along with the at least one basic key map.

2. The method of claim 1, wherein the displaying of the at least one optional key map comprises at least one of:
maintaining the at least one basic key map in a predetermined size; and
presenting each of sections of the optional key map in a size substantially identical with a size of each of key sections of the at least one basic key map.

3. The method of claim 1, further comprising:
creating the at least one optional key map by selecting at least one character included in the at least one basic key map in response to an input signal, and registering the at least one selected character with the at least one optional key map.

4. The method of claim 3, further comprising at least one of:
saving the at least one optional key map with a link to the at least one basic key map;
saving, when a specific basic key map is displayed before the displaying of the at least one basic key map of which specific characters are registered with the optional key map, the at least one optional key map with a link to the specific basic key map; and
saving the at least one optional key map with the link to a currently activated user function.

5. The method of claim 4, wherein the saving of the at least one the optional key map comprises at least one of:
saving the at least one optional key map with links to a plurality of basic key maps; and
saving the at least one basic key map with links to a plurality of optional key maps.

6. The method of claim 3, wherein the registering of the at least one selected character comprises:
displaying an optional key registration region having at least one section; and
registering the character selected in response to user input with one of the at least one section.

7. The method of claim 6, wherein the registering of the character comprises at least one of:
registering a plurality of characters with one of the at least one section of the optional key registration region; and
increasing a number of sections of the optional key registration region in response to an input signal.

8. The method of claim 1, further comprising configuring a dual key map display mode, for displaying the at least one basic key map and the at least one optional key map simultaneously, and a single key map display mode for displaying only the at least one basic key map.

9. The method of claim 8, wherein the displaying of the at least one optional key map comprises determining, when the dual key map display mode is selected, whether the optional key linked to the currently displayed at least one basic key map exists, and displaying, when the optional key linked to the currently displayed at least one basic key map, the basic key map and the at least one optional key map simultaneously.

10. An apparatus for operating an optional key map of a portable terminal, the apparatus comprising:
a storage unit for storing at least one basic key map generated according to a predetermined standard and at least one optional key map linked to the at least one basic key map;
a control unit for controlling to display the at least one basic key map and the at least one optional key map according to an input signal for displaying the at least one basic key map; and
a touchscreen for displaying the at least one basic key map and the at least one optional key map.

11. The apparatus of claim 10, wherein the control unit controls to display the at least one basic key map in a predetermined size and to display sections of the at least one optional key map in a size substantially identical with a size of each of sections of the at least one basic key map.

12. The apparatus of claim 10, wherein the touchscreen displays a region with which at least one character included in the at least one basic key map is registered for creating the at least one optional key map.

13. The apparatus of claim 10, wherein the control unit performs at least one of saving the at least one optional key map with a link to the at least one basic key map, saving, when a specific basic key map is displayed before displaying the at least one basic key map of which specific characters are registered with the optional key map, the at least one optional key map with a link to the specific basic key map, and saving the at least one optional key map with the link to a currently activated user function.

14. The apparatus of claim 13, wherein the storage unit performs at least one of saving the at least one optional key map with links to a plurality of basic key maps and saving the at least one basic key map with links to a plurality of optional key maps.

15. The apparatus of claim 10, wherein the control unit determines when the portable terminal is in a dual key map display mode for displaying the at least one basic key map or the at least one optional key map simultaneously and a single key map display mode for displaying only the at least one basic key map and controls, when the portable terminal is in the dual key map display mode, to display the at least one basic key map and the at least one optional key map simultaneously.

16. A method for operating a portable terminal, the method comprising:
executing a function of the portable terminal;
determining if the executed function requires an associated basic key map; and
if it is determined that the executed function requires an associated basic key map, configuring an optional key map.

17. The method of claim 16, further comprising:
linking the optional key map with the associated basic key map; and
storing the optional key map, the associated basic key map in a memory and the link between the optional key map and the associated basic key map.

18. The method of claim 16, wherein the configuring of the optional key map comprises:
displaying an optional key map registration region; and
registering one or more selected characters.
